(19) United States
(12) Patent Application Publication
(10) Pub. No.: US 2022/0238904 A1
(43) Pub. Date: Jul. 28, 2022

(54) REDOX FLOW BATTERY

(71) Applicant: TOYO ENGINEERING CORPORATION, Tokyo (JP)

(72) Inventor: Takato NAKAO, Narashino-shi, Chiba (JP)

(73) Assignee: TOYO ENGINEERING CORPORATION, Tokyo (JP)

(21) Appl. No.: 17/614,030

(22) PCT Filed: May 28, 2020
(86) PCT No.: PCT/JP2020/021088

§ 371 Date: Nov. 24, 2021

(30) Foreign Application Priority Data
May 30, 2019 (JP) 2019-101058

(51) Int. Cl. H01M 8/18; H01M 8/0206; H01M 8/0213; H01M 8/0228; H01M 8/0258; H01M 8/026; H01M 8/0265; H01M 8/1004; H01M 8/2475; H01M 8/2428

(52) U.S. Cl. CPC H01M 8/188; H01M 8/0206; H01M 8/0213; H01M 8/0228; H01M 8/2428; H01M 8/026; H01M 8/0265; H01M 8/1004; H01M 8/2475; H01M 8/0258

(57) ABSTRACT

Redox flow battery includes cell frame 20 including frame body 21 and bipolar plate 23, frame body 21 having rectangular opening 22 divided into a plurality of small openings 22a-22c along first direction X parallel to a longitudinal direction of opening 22, bipolar plate 23 divided into a plurality of regions 23a-23c, each of regions 23a-23c disposed within each of small openings 22a-22c to form a plurality of recesses, and electrode 11 divided into a plurality of regions 11a-11c, each of regions 11a-11c received in each of the recesses, wherein each of small openings 22a-22c has a rectangular shape whose longitudinal direction is parallel to first direction X.

### TECHNICAL FIELD

The present invention relates to a redox flow battery.

### BACKGROUND ART

Conventionally, as a secondary battery for energy storage, a redox flow battery is known which is charged and discharged through a redox reaction of active materials contained in an electrolyte solution. The redox flow battery has features such as easy increase in capacity, long life, and accurate monitoring of its state of charge. Because of these features, in recent years, the redox flow battery has attracted a great deal of attention, particularly for application in stabilizing the output of renewable energy whose power production fluctuates widely or leveling the electric load.

To obtain a predetermined voltage, a redox flow battery generally includes a cell stack having a plurality of cells that are stacked. Further, by installing a plurality of cell stacks, high power requirements ranging from several MW to several tens of MW can be met (see, for example, Non-Patent Literature 1). On the other hand, focusing on a cost reduction effect due to economies of scale, for the purpose of meeting the high power requirements, it is also conceivable to increase the size of each cell in the cell stack, instead of increasing the number of cell stacks (see, for example, Non-Patent Literature 2).

### CITATION LIST

### Non-Patent Literature

Non-Patent Literature 1: Keiji Yano et al., “Development and demonstration of redox flow battery system”, SEI Technical Review, January 2017, No. 190, p. 15-20 Non-Patent Literature 2: Puiki Leung et al., “Progress in redox flow batteries, remaining challenges and their applications in energy storage”, RSC Advances, Royal Society of Chemistry, 2012, Vol. 2, p. 10125-10156

### SUMMARY OF THE INVENTION

### Technical Problem

The increase in size of the cell requires increasing the sizes of a frame body and a bipolar plate that constitute the cell. However, the bipolar plate is generally made of a hard and brittle material, and when the size of the bipolar plate is increased, it is difficult to ensure sufficient mechanical strength. As a result, the bipolar plate may be broken to mix the positive and negative electrolyte solutions, resulting in failure such as self-discharge.

It is therefore an object of the present invention to provide a redox flow battery that achieves an increase in size of a cell while maintaining its mechanical strength.

### Solution to Problem

To achieve the above object, according to an aspect of the present invention, a redox flow battery includes a cell frame including a frame body and a bipolar plate, the frame body having a rectangular opening divided into a plurality of small openings along a first direction parallel to a longitudinal direction of the opening, the bipolar plate divided into a plurality of regions, each of the regions disposed within each of the small openings to form a plurality of recesses, and an electrode divided into a plurality of regions, each of the regions received in each of the recesses, wherein each of the small openings has a rectangular shape whose longitudinal direction is parallel to the first direction.

According to another aspect of the present invention, a redox flow battery includes a housing an electrode housed in the housing and held in a plate shape, a fluid flow mechanism for allowing flow of a fluid containing an active material through the electrode, wherein the fluid is supplied to a first surface of the electrode and collected from a second surface opposite to the first surface, or the fluid is supplied into the electrode and collected from the first or second surface, and a conductive member provided outside the housing and electrically connected to the electrode.

### Advantageous Effects of Invention

As described above, according to the present invention, an increase in size of the cell can be achieved while maintaining its mechanical strength.

### BRIEF DESCRIPTION OF THE DRAWINGS

FIG. 1A is a schematic configuration diagram of a redox flow battery according to a first embodiment;

FIG. 1B is a schematic configuration diagram of a cell stack that constitutes the redox flow battery according to the first embodiment;

FIG. 2 is an exploded plan view of the cell according to the first embodiment;

FIG. 3A is a plan view showing an additional example of an uneven flow prevention mechanism according to the first embodiment;

FIG. 3B is a perspective view of the uneven flow prevention mechanism shown in FIG. 3A;

FIG. 3C is an exploded perspective view of the uneven flow prevention mechanism shown in FIG. 3A;

FIG. 4 is a plan view showing another example of the cell frame according to the first embodiment;

FIG. 5 is a schematic configuration diagram of the cell stack that constitutes the redox flow battery according to a second embodiment;

FIG. 6A is a perspective view and a cross-sectional view of an electrode holder and a distribution plate according to the second embodiment;

FIG. 6B is a cross-sectional view taken along line A-A in FIG. 6A;

FIG. 6C is a cross-sectional view taken along line B-B in FIG. 6A;

FIG. 6D is a cross-sectional view taken along line C-C in FIG. 6A;

FIG. 7A is a diagram showing an exemplary configuration of the uneven flow preventing mechanism according to the second embodiment;

FIG. 7B is a diagram showing an exemplary configuration of the uneven flow prevention mechanism according to the second embodiment;

FIG. 8 is a schematic configuration diagram of the cell that constitutes the redox flow battery according to a third embodiment;

FIG. 9A is a cross-sectional view taken along line D-D in FIG. 8;

FIG. 9B is a cross-sectional view taken along line E-E in FIG. 8; and

FIG. 9C is a cross-sectional view taken along line F-F in FIG. 8.

### DESCRIPTION OF EMBODIMENTS

Embodiments of the present invention will be described below with reference to the drawings.

### First Embodiment

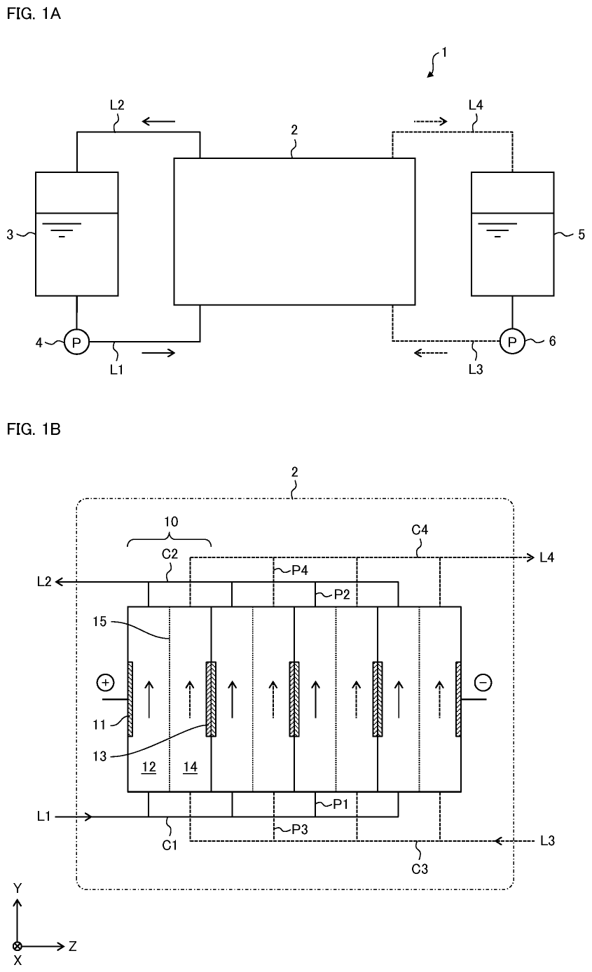

FIG. 1A is a schematic configuration diagram of a redox flow battery according to a first embodiment of the present invention. FIG. 1B is a schematic configuration diagram of a cell stack that constitutes the redox flow battery of this embodiment.

Redox flow battery 1 is configured to be charged and discharged through a redox reaction of positive- and negative-electrode active materials in cell 10, and includes cell stack 2 having a plurality of stacked cells 10. Cell stack 2 is connected to positive electrode-side tank 3 for storing a positive electrolyte solution through positive electrode-side incoming pipe L1 and positive electrode-side outgoing pipe L2. Positive electrode-side incoming pipe L1 is provided with positive electrode-side pump 4 for circulating the positive electrolyte solution between positive electrode-side tank 3 and cell stack 2. Cell stack 2 is connected to negative electrode-side tank 5 for storing a negative electrolyte solution through negative electrode-side incoming pipe L3 and a negative electrode-side outgoing pipe L4. Negative electrode-side incoming pipe L3 is provided with negative electrode-side pump 6 for circulating the negative electrolyte solution between negative electrode-side tank 5 and cell stack 2. As the electrolyte solution, any fluid containing an active material may be used, such as a slurry formed by suspending and dispersing a granular active material in a liquid phase, or a liquid active material itself. Therefore, the electrolyte solution described herein is not limited to a solution of an active material.

Cells 10 are formed by alternately stacking a cell frame and a membrane unit, both of which will be described below. Detailed configurations of the cell frame and the membrane unit will be described below. Although four cells 10 are shown in FIG. 1B, the number of cells 10 in cell stack 2 is not limited thereto. As will be described in detail below, each cell 10 is divided into three regions in a direction perpendicular to stacking direction Z of cell stack 2 (i.e. in an X direction).

Each of cells 10 includes positive cell 12 that houses positive electrode 11, negative cell 14 that houses negative electrode 13, and membrane 15 that separates positive cell 12 and negative cell 14. Positive cell 12 is connected to positive electrode-side incoming pipe L1 through individual supply flow channel P1 and common supply flow channel C1, and is connected to positive electrode-side outgoing pipe L2 through individual return flow channel P2 and common return flow channel C2. This allows positive cell 12 to be supplied with the positive electrolyte solution containing the positive-electrode active material from positive electrode-side tank 3. Thus, in positive cell 12, an oxidation reaction occurs during a charge process in which the positive-electrode active material changes from a reduced state to an oxidized state, and a reduction reaction occurs during a discharge process in which the positive-electrode active material changes from the oxidized state to the reduced state. On the other hand, negative cell 14 is connected to negative electrode-side incoming pipe L3 through individual supply flow channel P3 and common supply flow channel C3, and is connected to negative electrode-side outgoing pipe L4 through individual return flow channel P4 and common return flow channel C4. This allows negative cell 14 to be supplied with the negative electrolyte solution containing the negative-electrode active material from negative electrode-side tank 5. Thus, in negative cell 14, a reduction reaction occurs during the charge process in which the negative-electrode active material changes from an oxidized state to a reduced state, and an oxidation reaction occurs during the discharge process in which the negative-electrode active material changes from the reduced state to the oxidized state.

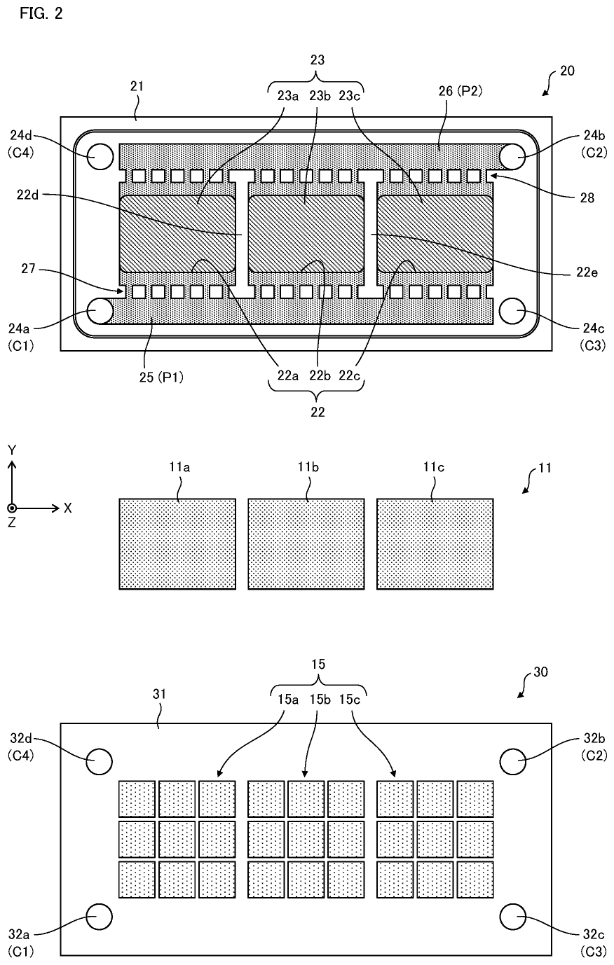

FIG. 2 is an exploded plan view of the cell of this embodiment, showing a plane viewed from the stacking direction of the cell stack. Here, a case is shown where the longitudinal directions of the cell frame and the membrane unit that constitute the cell are oriented horizontally, but this does not limit the position of the cell when used.

As described above, cells 10 are formed by alternately stacking cell frame 20 and membrane unit 30. Cell frame 20 separates adjacent cells 10 from each other and includes rectangular frame body 21. Frame body 21 has substantially rectangular opening 22, and opening 22 is divided into three small openings 22a-22c along its longitudinal direction (first direction) X. Specifically, opening 22 is divided into three rectangular small openings 22a-22c such that the longitudinal direction of each of small openings 22a-22c is parallel to longitudinal direction X of opening 22. Cell frame 20 includes rectangular bipolar plate 23. Bipolar plate 23 is divided into three regions 23a-23c, which are respectively disposed within small openings 22a-22c of opening 22. Thus, bipolar plate 23 includes three recesses formed on one surface thereof (i.e. on a side facing out of the page), and in these three recesses, three divided regions 11a-11c of positive electrode 11 are respectively received in contact with bipolar plate 23. Bipolar plate 23 also includes three recesses formed on the other surface thereof (i.e. on a side facing into the page), and in these three recesses, three divided regions (not shown) of negative electrode 13 are respectively received in contact with bipolar plate 23.

Membrane unit 30 includes membrane 15 divided into three regions 15a-15c and support frame 31 supporting membrane 15. Membrane unit 30 is stacked on cell frame 20 such that three regions 15a-15c of membrane 15 respectively face three regions 23a-23c of bipolar plate 23 and close the three recesses as described above. Thus, positive cell 12 divided into three regions is formed between one surface of bipolar plate 23 and membrane 15, and negative cell 14 divided into three regions is formed between the other surface of bipolar plate 23 and membrane 15. As a result, cell 10 is divided into three regions in longitudinal direction X of frame body 21.

Frame body 21 includes through-holes 24a-24d that are formed near four corners thereof and that penetrate respectively frame body 21 in thickness direction Z thereof. Similarly, support frame 31 includes through-holes 32a-32d that are formed near four corners thereof and that penetrate respectively support frame 31 in thickness direction Z thereof. Once cell frame 20 and membrane unit 30 are alternately stacked to form cell stack 2, through-holes 24a-24d, 32a-32d constitute common flow channels C1-C4 as described above, through which the electrolyte solution flows. Specifically, through-holes 24a, 32a on the lower left corner constitute common supply flow channel C1 for the positive electrolyte solution, and through-holes 24b, 32b on the upper right corner constitute common return flow channel C2 for the positive electrolyte solution. Through-holes 24c, 32c on the lower right corner constitute common supply flow channel C3 for the negative electrolyte solution, and through-holes 24d and 32d on the upper left corner constitute common return flow channel C4 for the negative electrolyte solution.

Further, frame body 21 includes two flow channel grooves 25, 26 formed on one surface thereof (i.e. on a side facing out of the page). Two flow channel grooves 25, 26 are adjacent to both sides of opening 22 in width direction (second direction) Y perpendicular to longitudinal direction X of opening 22, and extend in longitudinal direction X of opening 22. First flow channel groove 25 constitutes individual supply flow channel P1 for the positive electrolyte solution, connecting through-hole 24a (common supply flow channel C1) to the recess of positive cell 12 that receives positive electrode 11. Second flow channel groove 26 constitutes individual return flow channel P2 for the positive electrolyte solution, connecting the recess of positive cell 12 that receives positive electrode 11 to through-hole 24b (common return flow channel C2). Although not shown, frame body 21 also includes two flow channel grooves formed on the other surface thereof (i.e. on a side facing into the page). One of the flow channel grooves constitutes individual supply flow channel P3 for the negative electrolyte solution, connecting through-hole 24c (common supply flow channel C3) to the recess of negative cell 14 that receives negative electrode 13. The other of the flow channel grooves constitutes individual return flow channel P4 for the negative electrolyte solution, connecting the recess of negative cell 14 that receives negative electrode 13 to through-hole 24d (common return flow channel C4).

As described above, in this embodiment, opening 22 of frame body 21 is divided into three small openings 22a-22c, and accordingly bipolar plate 23 is also divided into three regions 23a-23c. Therefore, by maintaining the size of regions 23a-23c equal to that of the conventional bipolar plate, a reduction in the overall mechanical strength of bipolar plate 23 can be prevented even when the total size of bipolar plate 23 is increased. Further, frame body 21 includes beam-like portions 22d, 22e, each of which extends across opening 22 in width direction Y to divide opening 22 into three small openings 22a-22c, and these beam-like portions 22d, 22e function as a reinforcement to enhance the rigidity of frame body 21. This also can minimize the strength reduction associated with the increase in size of frame body 21. As a result, an increase in size of cell 10 can be achieved while maintaining the mechanical strength of cell 10 or cell frame 20.

In the illustrated embodiment, three regions 23a-23c of bipolar plate 23 are not electrically connected to each other, and thus the three divided regions of electrode cell 10 are also not electrically connected to each other. However, if there is a concern that the potential difference between the divided regions of cell 10 becomes large which degrades the charge/discharge performance, three regions 23a-23c of bipolar plate 23 may be electrically connected to each other. For that purpose, for example, frame body 21 may include conductive elements provided inside beam-like portions 22d, 22e that electrically connect three regions 23a-23c of bipolar plate 23. The number of each of opening 22 and bipolar plate 23 of frame body 21 is three in the illustrated embodiment, but is not limited thereto. Depending on the desired size of cell 10, opening 22 and bipolar plate 23 can each be divided into an appropriate number of regions. In other words, when it is desired to further increase the size of cell 10, opening 22 and bipolar plate 23 can each be divided into four or more regions.

Bipolar plate 23 must be liquid-tightly attached to opening 22 to prevent leakage of the electrolyte solution from the gap between opening 22 and bipolar plate 23. The fact that bipolar plate 23 is divided into the multiple regions is also preferable because it can improve the workability during such attachment. From the standpoint of resistance to the electrolyte solution (chemical resistance, acid resistance, or the like) as well as mechanical strength, a carbon-containing conductive material is generally used as a material of bipolar plate 23. However, if higher mechanical strength is required, bipolar plate 23 that is a carbon-plated metal plate may be used. On the other hand, frame body 21 is made of an insulating material. As the material of frame body 21, a material may be used that has an appropriate rigidity, that does not react with an electrolyte solution, and that has resistance to it. Such materials include, for example, vinyl chloride, polyethylene, and polypropylene.

Membrane 15 may not necessarily be divided into multiple regions, and for example may be provided on the entire surface of frame body 21. However, an area of frame body 21 other than opening 22 does not come into contact with the electrolyte solution, and thus does not function as cell 10 even when membrane 15 that is an ion exchange membrane is provided on that area. This results in waste of expensive ion exchange membrane. Further, there is also a concern that an increase in size of membrane 15 may lead to insufficient strength or deterioration of handleability. Thus, membrane 15 is also preferably divided into multiple regions 15a-15c. In addition, as shown, each of regions 15a-15c of membrane 15 is more preferably divided into a matrix of small regions. The number of divisions of membrane 15 may not be the same as the number of divisions of opening 22 or bipolar plate 23. On the other hand, support frame 31 is preferably formed of a material having a higher strength than that of membrane 15. Such materials include, for example, plastics.

As materials of electrodes 11, 13, a carbon material is preferably used, and its forms include felt-like and sheet-like. However, from the standpoint of ease and cost of uniformly installing the required amount of electrode materials in cells 12, 14, a pellet-like carbon material may also be used. Specific forms of the pellet, for example, include forms such as spherical, granular, tablet-shaped, and ring-shaped, and an extruded form having a multilobed cross section.

In the meantime, if the length of opening 22 in longitudinal direction X increases with increasing the size of frame body 21, the length of cell 10 in longitudinal direction X may also increases, and the electrolyte solution may flow unevenly through cell 10. Such uneven flow may be prevented to some extent by beam-like portions 22d, 22e formed between small openings 22a-22c, but its effect is limited. For that reason, in this embodiment, first communication section 27 is formed between first flow channel groove 25 and opening 22, which consists of a plurality of grooves communicating first flow channel groove 25 with opening 22. Further, second communication section 28 is also formed between second flow channel groove 26 and opening 22, which consists of a plurality of grooves communicating second flow channel groove 26 with opening 22. The grooves constituting each of communication sections 27, 28 are arranged in longitudinal direction X of opening 22 between each of flow channel grooves 25, 26 and opening 22. Since communication sections 27, 28 thus provided supplies the electrolyte solution to cell 10 so as to distribute it in longitudinal direction X of opening 22, the occurrence of uneven flow as described above can be prevented and the charge/discharge performance can be maximized. To more effectively prevent the uneven flow, communication sections 26, 27 are preferably formed throughout the length of opening 22 in longitudinal direction X. Therefore, flow channel grooves 25, 26 also preferably extend throughout the length of opening 22 in longitudinal direction X.

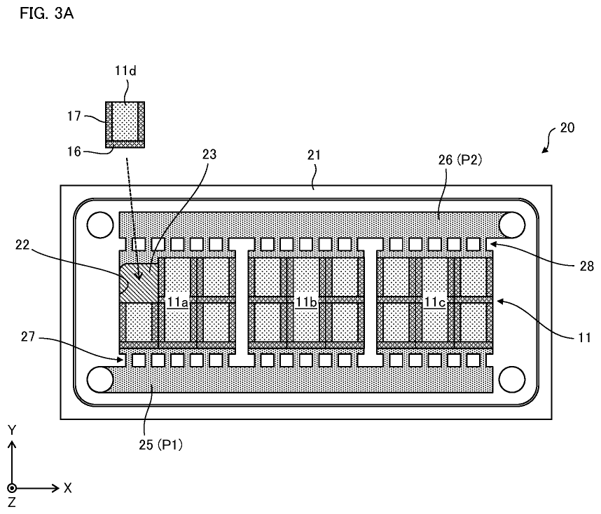

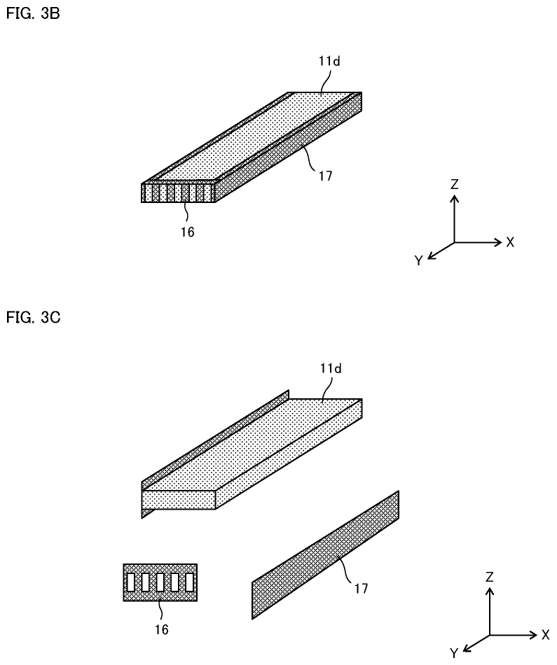

An uneven flow prevention mechanism for preventing the electrolyte solution from flowing unevenly through cell 10 is not limited to communication section 27, 28 as described above, and other configurations may be additionally employed. FIG. 3A is a plan view showing such an additional uneven flow prevention mechanism installed in the cell frame. FIG. 3B is a perspective view of the uneven flow prevention mechanism shown in FIG. 3A, and FIG. 3C is an exploded perspective view thereof.

Referring to FIG. 3A, each of regions 11a-11c of positive electrode 11 is further divided into three in longitudinal direction X of opening 22 and two in width direction Y thereof, i.e., six small regions (electrode pieces) 11d. Perforated sheet 16 having a plurality of holes is provided on a side of each electrode piece 11d into which the electrolyte solution flows, i.e., on a side facing first flow channel groove 25. In addition, flow directing sheet 17 is provided on two sides adjacent to the side of each electrode piece 11d, on which perforated sheet 16 is provided. Perforated sheet 16 facilitates distribution of the electrolyte solution in longitudinal direction X of opening 22, and flow directing sheet 17 prevents diffusion of the electrolyte solution in longitudinal direction X of opening 22. Thus, uneven flow of the electrolyte solution through cell 10 can be further prevented. To prevent the electrolyte solution from passing between adjacent flow directing sheets 17, adjacent flow directing sheets 17 are preferably joined to each other. As materials of perforated sheet 16 and flow directing sheet 17, a material may be used that has flexibility adaptable to the internal shape of cell 10 and has resistance to the electrolyte solution. Such materials include, for example, plastics.

The installation position and the number of perforated sheets 16 are not particularly limited as long as they are arranged along longitudinal direction X of opening 22 in cell 10. Therefore, perforated sheet 16 may be provided only on an end surface of each of regions 11a-11c of positive electrode 11 that faces first flow channel groove 25. In this case, each of regions 11a-11c of positive electrode 11 may not be necessarily divided in width direction Y of opening 22. On the other hand, flow directing sheet 17 can provide desired effects as long as it is arranged along width direction Y of opening 22 in cell 10. However, for this purpose, each of regions 11a-11c of positive electrode 11 must be divided into two or more small regions (electrode pieces) in longitudinal direction X of opening 22.

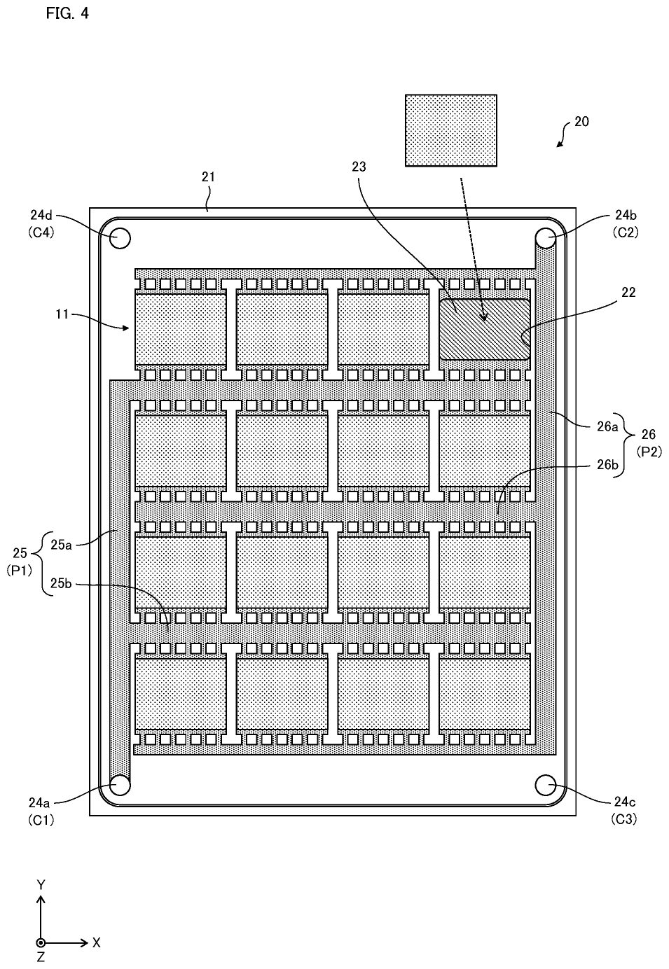

In the above embodiment, while the length of opening 22 in the flow direction of the electrolyte solution (i.e. in a Y direction) is maintained equal to that in the conventional case, the length of opening 22 in a direction perpendicular to the flow direction (i.e. in the X direction) is increased, which can lead to the increase in size of cell 10. With this configuration, the occurrence of problems that may occur with the increase in size of cell 10 can also be prevented. Specifically, an increase in height (i.e. length in the Y direction) of electrodes 11, 13 may lead to an increase in pressure drop when the electrolyte solution passes through electrodes 11, 13, and an increase in thickness (i.e. length in the Z direction) of electrodes 11, 13 may lead to an increase in internal resistance of cell 10, but such increases in both the pressure drop and the internal resistance can be prevented. On the other hand, by forming a plurality of openings 22 in frame body 21 along the flow direction of the electrolyte solution (i.e. along the Y direction), the size of cell 10 in the flow direction can be increased while preventing the increase in pressure drop and internal resistance as described above. FIG. 4 is a plan view showing an exemplary configuration of the cell frame having the frame body with such openings.

Referring to FIG. 4, openings 22 are arranged along width direction Y of opening 22 such that longitudinal directions X of openings 22 are parallel to each other. First flow channel groove 25 is composed of first common flow channel groove 25a extending in arrangement direction Y of openings 22, and a plurality of first individual flow channel grooves 25b each extending in longitudinal direction Y of opening 22. Similarly, second flow channel groove 26 is composed of second common flow channel groove 26a extending in arrangement direction Y of opening 22, and a plurality of second individual flow channel grooves 26b each extending in longitudinal direction Y of opening 22. First common flow channel groove 25a extends upward from through-hole 24a on the lower left corner, and second common flow channel groove 26a extends downward from through-hole 24b on the upper right corner. First individual flow channel grooves 25b and second individual flow channel grooves 26b are alternately arranged between openings 22 adjacent to each other in arrangement direction Y, and are each connected to adjacent openings 22.

As described above, cell frame 20 shown in FIG. 4 is not configured to increase the size of electrodes 11, 13 by increasing the size of opening 22 in the flow direction of the electrolyte solution (i.e. in the Y direction), but to increase the number of electrodes 11, 13 by increasing the number of openings 22. As a result, a high output power can be achieved by increasing the total size of cell 10, while preventing an increase in size of electrodes 11, 13. Thus, even in cell frame 20 shown in FIG. 4, the occurrence of the above-described problems that may occur with the increase in size of cell 10 can be prevented. Specifically, since the length of flow channel in electrodes 11, 13 through which the electrolyte solution flows in height direction Y is not increased, its pressure drop can be prevented from increasing. Further, since the thickness (i.e. the length in the Z direction) of electrodes 11, 13 is not also increased, the internal resistance of electrodes 11, 13 can be prevented from increasing. In cell frame 20 shown in FIG. 4, four openings 22 are formed in frame body 21, each of which is divided into four small openings, but the number of openings 22 is not particularly limited and the number of small openings is also not particularly limited. Frame body 21 may therefore include two, three, or five or more openings 22, and each opening 22 may also be divided into two, three, or five or more small openings.

### Second Embodiment

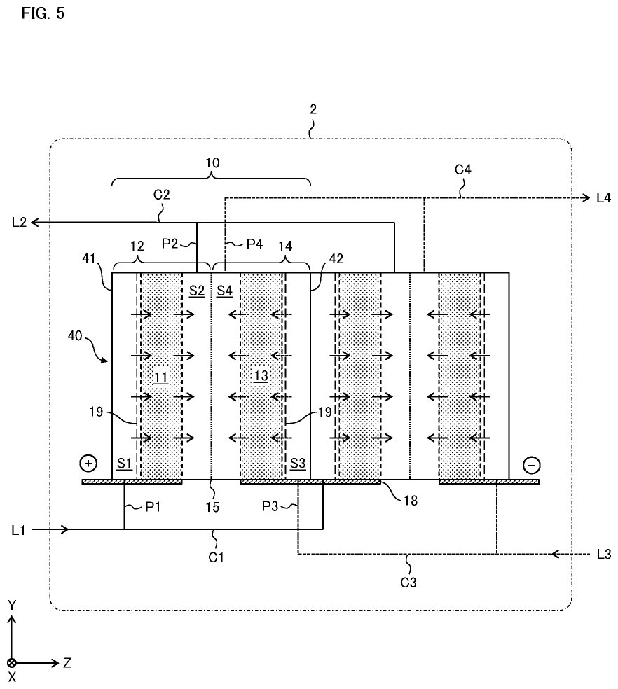

FIG. 5 is a schematic configuration diagram of the cell stack which constitutes the redox flow battery according to a second embodiment of the present invention. This embodiment is a variation of the first embodiment, and differs from the first embodiment in that no bipolar plate is provided. Hereinafter, components identical to those of the first embodiment will be denoted by the same reference numerals in the drawings, description thereof will be omitted, and only components that are different from those of the first embodiment will be described.

In this embodiment, cell 10 is composed of a flattened cuboid-shaped cell case (housing) 40. Therefore, cell stack 2 is formed by stacking a plurality of cell cases 40. Cell case 40 includes a pair of bulkheads 41, 42 which are opposed to each other in stacking direction Z of cell stack 2 and between which membrane 15 is disposed. Therefore, positive cell 12 is formed between first bulkhead 41 and membrane 15, and negative cell 14 is formed between second bulkhead 42 and membrane 15. As a material of cell case 40, a material is preferably used that has an appropriate rigidity, that does not react with an electrolyte solution, and that has resistance to it. Such a material may be, for example, an insulating material that is similar to that of frame body 21 of the first embodiment. The number of cells 10 in cell stack 2 is not limited to the illustrated one.

Positive electrode 11 is housed in positive cell 12 while being held in a plate shape by an electrode holder as described below. Positive electrode 11 is spaced apart from and faces first bulkhead 41 on one side of two opposite surfaces (first and second surfaces) thereof, and is spaced apart from and faces membrane 15 on the other side. Thus, positive cell 12 includes space S1 formed between first bulkhead 41 and one surface of positive electrode 11, and space S2 formed between the other surface of positive electrode 11 and membrane 15. Negative electrode 13 is also housed in negative cell 14 while being held in a plate shape by an electrode holder as described below. Negative electrode 13 is spaced apart from and faces second bulkhead 42 on one side of two opposite surfaces (first and second surfaces) thereof, and is spaced apart from and faces membrane 15 on the other side. Thus, negative cell 14 includes space S3 formed between second bulkhead 42 and one surface of negative electrode 13, and space S4 formed between the other surface of negative electrode 13 and membrane 15. As materials of electrodes 11, 13, not only a felt-like or sheet-like carbon material but also a pellet-like carbon material may be used, as in the first embodiment.

Individual flow channels P1-P4, each of which is configured as an independent piping member, are connected to cell case 40 and communicate with the interior of cell 10. Individual supply flow channel P1 for the positive electrolyte solution is connected to space S1 in positive cell 12, and individual return flow channel P2 is connected to space S2 in positive cell 12. Therefore, the positive electrolyte solution is supplied from individual supply flow channel P1 to positive electrode 11 through the space S1, flows through positive electrode 11 in thickness direction Z, and then is returned from space S2 to individual return flow channel P2. In other words, space S1 functions as a fluid supply for supplying the positive electrolyte solution to positive electrode 11, and space S2 functions as a fluid collector for collecting the positive electrolyte solution from positive electrode 11, which constitute a fluid flow mechanism for allowing flow of the positive electrolyte solution through positive electrode 11. Individual supply flow channel P3 for the negative electrolyte solution is connected to space S3 in negative cell 14, and individual return flow channel P4 is connected to space S4 in negative cell 14. Therefore, the negative electrolyte solution is supplied from individual supply flow channel P3 to negative electrode 13 through space S3, flows through negative electrode 13 in thickness direction Z, and then is returned from space S4 to individual return flow channel P4. In other words, space S3 functions as a fluid supply for supplying the negative electrolyte solution to negative electrode 13, and space S4 functions as a fluid collector for collecting the negative electrolyte solution from negative electrode 13, which constitute a fluid flow mechanism for allowing flow of the negative electrolyte solution through negative electrode 13. In this embodiment, similarly to individual flow channels P1-P4, each of common flow channels C1-C4 is also configured as a separate piping member that is independent of cell case 40.

In the first embodiment, the electrical connection between positive and negative electrodes 11, 13 is established by bipolar plate 23, but in this embodiment, conductive member 18 is provided instead of such a bipolar plate. Conductive member 18 is disposed outside cell case 40 and functions to electrically connect positive and negative electrodes 11, 13 of adjacent cells 10. Specifically, conductive member 18 is connected through an opening (not shown) formed on a side of cell case 40 to a current collecting portion of an electrode holder as described below, so as to be electrically connected to positive electrode 11 or negative electrode 13. The use of conductive member 18 is not desirable because its electrical path length is longer and its cross-sectional area is smaller as compared with the case of using bipolar plate 23, but is advantageous in that the resistance to the electrolyte solution need not be taken into account because of no contact with the electrolyte solution. Therefore, as a material of conductive member 18, a metal material having high conductivity may be used. On the other hand, unlike bipolar plate 23, conductive member 18 does not require so high mechanical strength, and therefore a highly conductive carbon material may also be selected as a material of conductive member 18. Conductive member 18 may be provided on up to four sides of cell case 40, so as to further reduce the electrical resistance between positive and negative electrodes 11, 13.

Thus, in this embodiment, there does not exist a bipolar plate which may cause a problem of mechanical strength reduction when the size of cell 10 is increased. As a result, an increase in size of cell 10 can be achieved without a large reduction in mechanical strength. In addition, the supply and return of the electrolyte solution with respect to cell 10 are performed by separate piping members C1-C4, P1-P4 that are independent of cell case 40. Therefore, there is no need to form a groove serving as a flow channel of the electrolyte solution in cell case 40 itself, and a cost reduction effect due to economies of scale can be further expected. Further, since the electrolyte solution flows through electrodes 11, 13 in thickness direction Z, a large increase in pressure drop when the electrolyte solution passes through electrodes 11, 13 can also be prevented even if the size of cell 10 is increased. As described above, there is also a concern that an increase in size of membrane 15 may lead to insufficient strength or deterioration of handleability. For that reason, as in the first embodiment, membrane 15 of this embodiment may be divided into a plurality of regions, and alternatively or in addition, it may be divided into a plurality of small regions. In this case, the regions or the small regions may be supported on a support frame made of, for example, plastic.

If the plane size of electrodes 11, 13 (i.e. the size of it in the XY plane) increases with increasing the size of cell 10, the electrolyte solution may flow unevenly through electrodes 11, 13 in thickness direction Z. For that reason, in this embodiment, distribution plate 19 is provided in supply spaces S1, S3 to face electrodes 11, 13. Distribution plate 19 has a matrix of holes as described below. Thus, the electrolyte solution that has been supplied into supply spaces S1, S3 is uniformly distributed on the surfaces of electrodes 11,13. As a result, the occurrence of uneven flow as described above can be prevented and the charge/discharge performance can be maximized. Distribution plate 19 may also be provided in collection spaces S2, S4.

The direction in which the electrolyte solution passes through each of electrodes 11, 13 may be opposite to the illustrated direction. Specifically, in positive cell 12, the positive electrolyte solution may flow from space S2 adjacent to membrane 15 toward space S1 adjacent to bulkhead 41. In other words, individual supply flow channel P1 may be connected to space S2 adjacent to membrane 15, and individual return flow channel P2 may be connected to space S1 adjacent to bulkhead 41. Further, in negative cell 14, the negative electrolyte solution may flow from space S4 adjacent to membrane 15 toward space S3 adjacent to bulkhead 41. In other words, individual supply flow channel P3 may be connected to space S4 adjacent to membrane 15, and individual return flow channel P4 may be connected to space S3 adjacent to bulkhead 42. In this case, distribution plate 19 is preferably provided in spaces S2, S4 adjacent to membrane 15.

The direction in which the electrolyte solution passes through each of electrodes 11, 13 may be different between the charge and discharge processes. As an example, a pipe switching device may be provided between positive electrode-side incoming pipe L1 and positive electrode-side outgoing pipe L2, as well as between negative electrode-side incoming pipe L3 and negative electrode-side outgoing pipe L4, so as to change the flow direction of the electrolyte solution when switching between the charge and discharge processes. In this case, distribution plate 19 is preferably provided not only in spaces S1, S3 adjacent bulkheads 41, 42 but also in spaces S2, S4 adjacent to membrane 15.

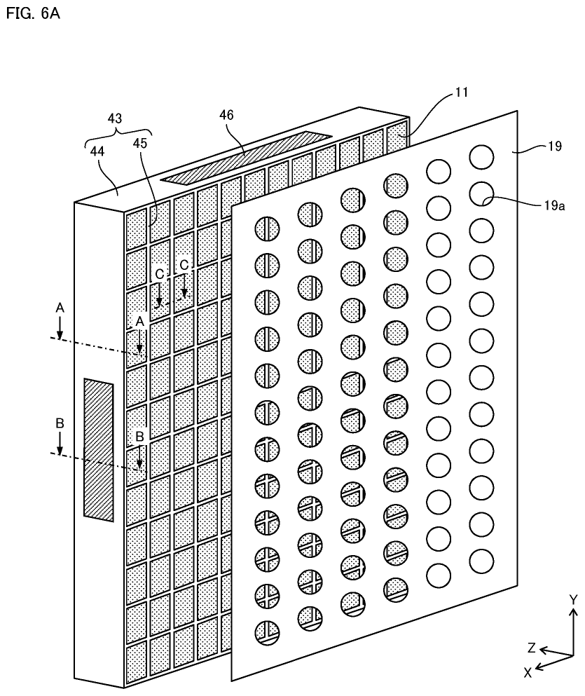

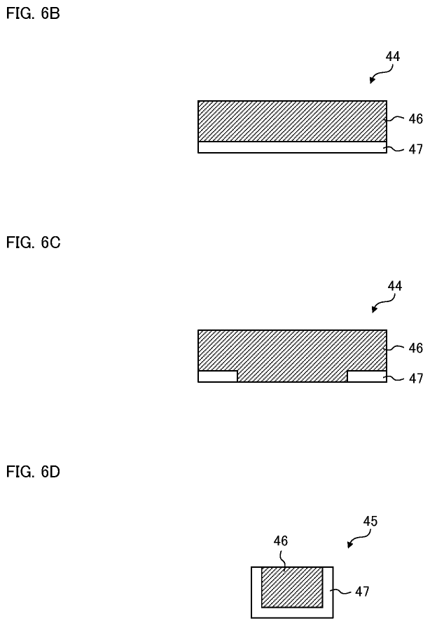

The configuration of an electrode holder housed in the cell case and holding each electrode in a plate shape will be described here. The electrode holder holding the positive electrode and the electrode holder holding the negative electrode have the same configuration. Therefore, only the configuration of the electrode holder holding the positive electrode will be described below. FIG. 6A is a perspective view of the electrode holder holding the positive electrode and the distribution plate provided in conjunction therewith. FIGS. 6B-6D are cross-sectional views of a current collecting portion and a reinforcement portion which constitute the electrode holder, FIG. 6B being a cross-sectional view taken along line A-A in FIG. 6A, FIG. 6C being a cross-sectional view taken along line B-B in FIG. 6A, and FIG. 6D being a cross-sectional view taken along line C-C in FIG. 6A.

Electrode holder 43 is formed in a flat rectangular parallelepiped shape, and includes frame member 44 constituting four sides of the rectangular parallelepiped and grid member 45 constituting the remaining two sides of the rectangular parallelepiped. Electrode holder 43 houses positive electrode 11 therein, and is housed in cell case 40 such that a pair of opposite grid members 45 faces first bulkhead 41 and membrane 15. This allows the positive electrolyte solution to flow into positive electrode 11 through one of grid members 45, flow through positive electrode 11 in thickness direction Z, and then flow out of positive electrode 11 through the other of grid members 45.

Frame member 44 and grid member 45 are each composed of current collecting portion 46 and reinforcement portion 47. Current collecting portion 46 is made of a conductive material and forms the inner surfaces, i.e. surfaces facing and contacting positive electrode 11, of frame member 44 and grid member 45. As a material of current collecting portion 46, a carbon material having high conductivity is preferably used. Reinforcement portion 47 functions to reinforce current collecting portion 46 and is preferably formed of a material having a higher strength than that of membrane 15 Such materials include, for example, plastics. Reinforcement portion 47 forms the outer surfaces of frame member 44 and grid member 45, but is not provided on a portion of the outer surface of frame member 44. Therefore, current collecting portion 46 is exposed on the outer surface of frame member 44 through that portion, and conductive member 18 is connected to the portion thus exposed. This allows electrical connection between connect conductive member 18 and positive electrode 11. The location where current collecting portion 46 is exposed is not limited to the illustrated one as long as current collecting portion 46 is exposed to the outside through at least one portion of frame member 44. When a material having a certain level of mechanical strength, such as a carbon-plated metal plate, is used as a material of current collecting portion 46, reinforcement portion 47 is not necessarily provided.

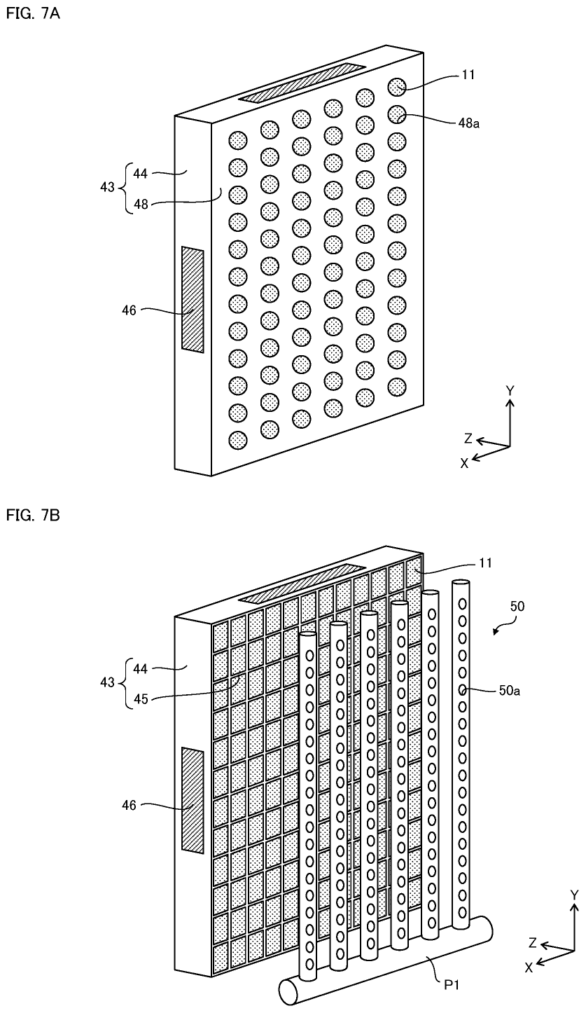

As described above, distribution plate 19 has a matrix of holes 19a and is provided to face grid member 45 of electrode holder 43. Such distribution plate 19 can uniformly distribute the positive electrolyte solution that has passed through holes 19a onto the surface of positive electrode 11, preventing the electrolyte solution from flowing unevenly through positive electrode 11 in thickness direction Z. However, the uneven flow prevention mechanism for the electrolyte solution in this embodiment is not limited to such distribution plate 19, and other configurations may be employed. FIGS. 7A and 7B are perspective views showing other examples of such uneven flow prevention mechanism.

In the example shown in FIG. 7A, distribution plate 19 is not provided, but instead electrode holder 43 itself is provided with the uneven flow prevention mechanism. Specifically, electrode holder 43 includes distribution plate member 48 provided on a side thereof facing bulkhead 41. Distribution plate member 48 includes a matrix of holes 48a, which can produce the same effects as those produced by distribution plate 19. Like the frame member 44, distribution plate member 48 is composed of current collecting portion 46 forming the inner surface of electrode holder 43 and reinforcement portion 47 forming the outer surface thereof. Distribution plate member 48 may also be provided on a side of electrode holder 43 that faces membrane 15.

On the other hand, in the example shown in FIG. 7B, a plurality of electrolyte solution introduction pipes (fluid introduction pipes) 50 each having a plurality of supply ports 50a are provided instead of distribution plate 19. Electrolyte solution introduction pipes 50 are connected to individual supply flow channel P1 and function as a fluid supply for supplying the positive electrolyte solution to positive electrode 11 through supply ports 50a. On the other hand, since supply ports 50a of each electrolyte solution introduction pipe 50 open toward bulkhead 41 (i.e. in the negative direction of the Z-axis), electrolyte solution introduction pipes 50 also function to distribute the positive electrolyte solution uniformly over positive electrode 11. Thus, also in this example, the same effects as those produced by distribution plate 19 can be produced.

In this embodiment, even if the number of stacked cells 10 is the same as in the first embodiment, the size of cell stack 2 in stacking direction Z is larger than that in the first embodiment due to the structural difference between cell frame 20 and cell case 40. Therefore, in the first embodiment, as a method of securing cell stack 2, a method is generally used where stacked bodies each composed of cell frame 20 and membrane unit 30 are secured together, but in this embodiment, each adjacent pair of cell cases 40 may be individually secured. When it is desired to further increase the size of cell 10, from the standpoint of maintaining mechanical strength, cell case 40 may be composed of two half cases each constituting positive cell 12 and negative cell 14. Also in this case, each pair of the two half cases, that are adjacent to each other with membrane 15 interposed therebetween, may be individually secured, and each cell case 40 thus secured may be individually secured to adjacent cell case 40. Such a method is preferable because cell stack 2 can be assembled more easily, as compared with the method of entirely securing cell stack 2 as in the first embodiment.

### Third Embodiment

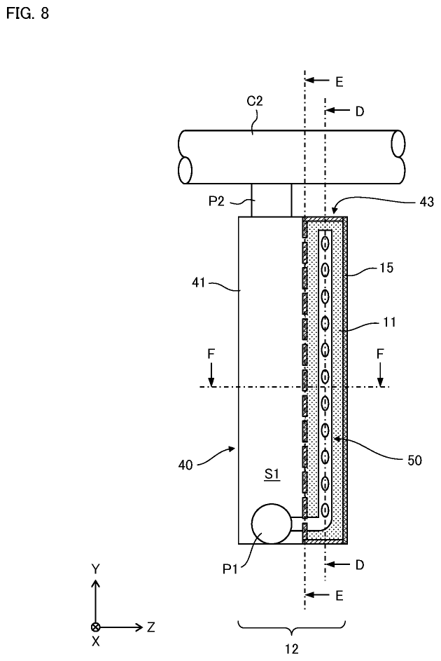

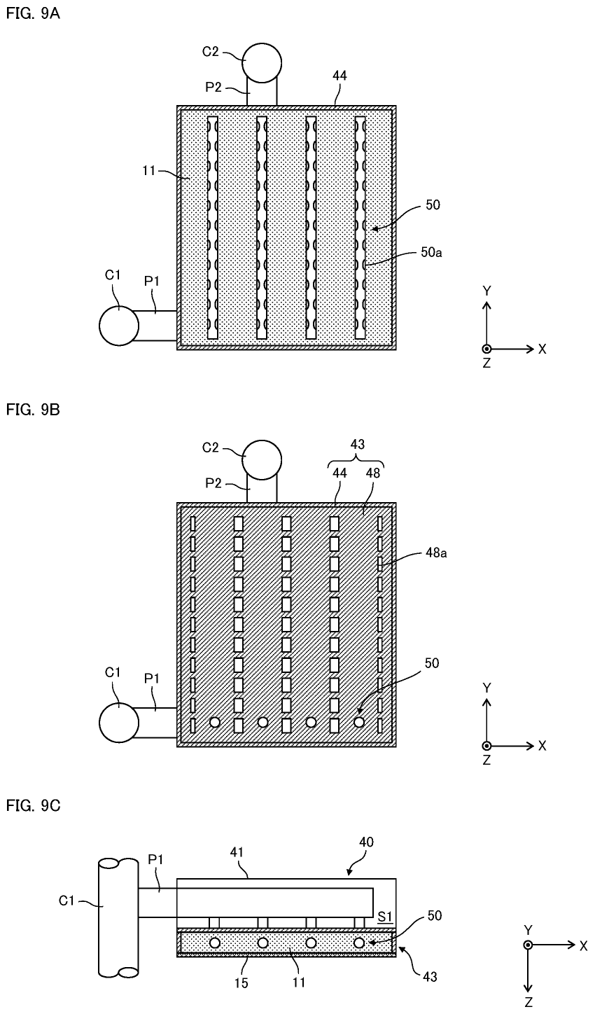

FIG. 8 is a schematic side view showing a portion of the cell which constitutes the redox flow battery according to a third embodiment of the present invention, specifically a schematic side view of the positive cell. FIG. 9A is a cross-sectional view taken along line D-D in FIG. 8, FIG. 9B is a cross-sectional view taken along line E-E in FIG. 8, and FIG. 9C is a cross-sectional view taken along line F-F in FIG. 8. This embodiment is a variation of the second embodiment, and differs from the second embodiment in terms of the fluid flow mechanism for allowing flow of the electrolyte solution through the electrode. Hereinafter, components identical to those of the second embodiment will be denoted by the same reference numerals in the drawings, description thereof will be omitted, and only components that are different from those of the second embodiment will be described. It should be noted that since the positive cell and the negative cell have substantially the same configuration, the following description for the positive cell applies to the negative cell as well.

From the standpoint of preventing an increase in internal resistance of cell 10, the distance between positive electrode 11 and membrane 15 is preferably as short as possible. For that reason, in this embodiment, electrode holder 43 is configured to bring positive electrode 11 housed therein into contact with membrane 15. Specifically, electrode holder 43 has an open side facing membrane 15, and is housed in cell case 40 such that positive electrode 11 housed therein is brought into contact with membrane 15. Accordingly, space S2 is not formed between positive electrode 11 and membrane 15. Therefore, individual return flow channel P2 is connected to space S1 formed between positive electrode 11 and first bulkhead 41. In addition, in this embodiment, electrolyte solution introduction pipes 50 similar to the second embodiment are provided as a fluid supply for supplying the positive electrolyte solution to positive electrode 11. However, electrolyte solution introduction pipes 50 are not inserted into space S1 formed between positive electrode 11 and first bulkhead 41, but into the inside of positive electrode 11. Accordingly, supply ports 50a of each electrolyte solution introduction pipe 50 open toward the side of positive electrode 11 (i.e. in the positive or negative direction of the X-axis). In addition, electrode holder 43 includes distribution plate member 48, which is similar to the second embodiment except for the shape and arrangement of holes 48a, provided on a side facing first bulkhead 41. Holes 48a of distribution plate member 48 are disposed between electrolyte solution introduction pipes 50 when viewed in stacking direction Z of cell stack 2.

With this configuration, the positive electrolyte solution flows from individual supply flow channel P1 into positive electrode 11 through holes 50a of each electrolyte solution introduction pipe 50. Then, the positive electrolyte solution flows through positive electrode 11 in a direction perpendicular to thickness direction Z (i.e. in the positive or negative direction of the X-axis), flows into space S1 through holes 48a of distribution plate member 48, and then is returned from space S1 to individual return flow channel P2. Therefore, in this embodiment, space S1 functions as a fluid collector for collecting the positive electrolyte solution from positive electrode 11

As described above, according to this embodiment, the distance between positive electrode 11 and membrane 15 can be significantly shortened, and therefore, in addition to the effects obtained in the second embodiment, the internal resistance of cell 10 can be reduced. The positive electrolyte solution that has been supplied from electrolyte solution introduction pipe 50 initially flows through positive electrode 11 in the direction perpendicular to thickness direction Z (i.e. in the X direction), but finally flows through positive electrode 11 in thickness direction Z and is returned to space S1. Therefore, as compared with the second embodiment, a pressure drop which occurs when the positive electrolyte solution passes through positive electrode 11 does not significantly increase. As in the first embodiment, membrane 15 of this embodiment may be divided into a plurality of regions, and alternatively or in addition, it may be divided into a plurality of small regions. In this case, the regions or the small regions may be supported on a support frame made of, for example, plastic.

### REFERENCE SIGNS LIST

1 Redox flow battery
10 Cell
11, 11a-11c Positive electrode
12 Positive cell
13 Negative electrode
14 Negative cell
15, 15a-15c Membrane
16 Perforated sheet
17 Flow directing sheet
18 Conductive member
19 Distribution plate
20 Cell frame
21 Frame body
22 Opening
22a-22c Small opening
22d, 22e Beam-like portion
23, 23a-23c Bipolar plate
25, 26 Flow channel groove
27, 28 Communication section
30 Membrane unit
31 Support frame
40 Cell case
41, 42 Bulkhead
43 Electrode holder
44 Frame member
45 Grid member
46 Current collecting portion
47 Reinforcement portion
48 Distribution plate member
50 Electrolyte solution introduction pipe
50a Supply port
S1-S4 Space
X Longitudinal direction (of the opening)
Y Width direction (of the opening)

1-15. (canceled)

16. A redox flow battery comprising:
a housing;
an electrode housed in the housing and held in a plate shape;
a fluid flow mechanism for allowing flow of a fluid containing an active material through the electrode, wherein the fluid is supplied to a first surface of the electrode and collected from a second surface opposite to the first surface, or the fluid is supplied into the electrode and collected from the first or second surface; and
a conductive member provided outside the housing and electrically connected to the electrode.

17. The redox flow battery according to claim 16, wherein the fluid flow mechanism is configured to supply the fluid to the first surface of the electrode and collect the fluid from the second surface, and includes a fluid supply for supplying the fluid into the electrode and a fluid collector for collecting the fluid from the electrode.

18. The redox flow battery according to claim 17, wherein the housing includes a bulkhead spaced apart from and facing one surface of the first and second surfaces of the electrode and a membrane spaced apart and facing the other surface of the first and second surfaces of the electrode.

19. The redox flow battery according to claim 18, wherein the fluid supply is composed of a space formed in the housing between the first surface of the electrode and the bulkhead or membrane.

20. The redox flow battery according to claim 19, further comprising a distribution plate having a matrix of holes, the distribution plate provided facing the first surface of the electrode to distribute the fluid that has been supplied into the space over the first surface.

21. The redox flow battery according to claim 18, wherein the fluid supply includes a plurality of fluid introduction pipes provided in a space formed in the housing between the first surface of the electrode and the bulkhead or membrane.

22. The redox flow battery according to claim 21, wherein the fluid introduction pipe has a plurality of supply ports that open toward the bulkhead or membrane facing the first face.

23. The redox flow battery according to claim 18, wherein the fluid collector is composed of a space formed in the housing between the second surface of the electrode and the bulkhead or membrane.

24. The redox flow battery according to claim 16, wherein the fluid flow mechanism is configured to supply the fluid into the electrode and collect the fluid from the first or second surface, and includes a fluid supply for supplying the fluid into the electrode and a fluid collector for collecting the fluid from the electrode.

25. The redox flow battery according to claim 24, wherein the housing includes a bulkhead spaced apart from and facing one surface of the first and second surfaces of the electrode at a distance, and a membrane facing and contacting the other surface of the first and second surfaces of the electrode, and wherein the fluid supply is comprised of a plurality of fluid introduction pipes inserted into the electrode, and the fluid collector is comprised of a space formed in the housing between the one surface of the electrode and the bulkhead.

26. The redox flow battery according to claim 25, wherein the fluid introduction pipe has a plurality of supply ports that open toward a side of the electrode.

27. The redox flow battery according to claim 18, wherein the membrane is divided into a plurality of regions and supported by a support frame made of plastic.

28. The redox flow battery according to claim 27, wherein each of the regions of the membrane is divided into a plurality of small regions.

29. The redox flow battery according to claim 16, further comprising an electrode holder housed in the housing and holding the electrode in a plate shape.

30. The redox flow battery according to claim 29, wherein the electrode holder includes a current collection portion made of a conductive material and forming an inner surface of the electrode holder, at least a portion of the current collection portion exposed on an outer surface of the electrode holder, and wherein the conductive member is electrically connected to the at least a portion of the current collection portion.

31. The redox flow battery according to claim 30, wherein the electrode holder is made of plastic and includes a reinforcement forming an outer surface of the electrode holder to reinforce the current collection portion.

32. The redox flow battery according to claim 30, wherein the conductive material contains carbon.

33. The redox flow battery according to claim 25, wherein the membrane is divided into a plurality of regions and supported by a support frame made of plastic.

34. The redox flow battery according to claim 33, wherein each of the regions of the membrane is divided into a plurality of small regions.
